(19) United States
(12) Patent Application Publication
(10) Pub. No.: US 2012/0197612 A1
(43) Pub. Date: Aug. 2, 2012

(54) PORTABLE WIRELESS DEVICE FOR MONITORING NOISE

(75) Inventors: Clemens DREWS, San Jose, CA (US); Christine M. Robson, San Jose, CA (US); Thomas G. Zimmerman, Cupertino, CA (US)

(73) Assignee: International Business Machines Corporation, Armonk, NY (US)

(21) Appl. No.: 13/016,222

(22) Filed: Jan. 28, 2011

(51) Int. Cl. G06G 7/48; G06F 15/00

(52) U.S. Cl. 703/6; 702/199; 702/150

(57) ABSTRACT

Embodiments of the invention relate to generating a noise model for a given environment. According to one embodiment of the invention, sounds occurring within the given environment over a given period are monitored, and signals that each represent an amplitude of the sounds occurring within the given environment during a portion of the given period are generated. Average noise levels associated with the given environment over the given period are determined, and peak noise events occurring within the given environment over the given period are identified. The average noise levels and information indicating the peak noise events are stored or transmitted.

### BACKGROUND

The present invention generally relates to noise monitoring, and more particularly relates to monitoring noise using a portable wireless sensor.

Excessive, unwanted, or disturbing sound in the environment is called noise pollution. Noise affects our physical and mental health, increasing blood pressure and stress, damaging hearing and disturbing sleep. Unlike chemical pollution which can be measured with a single value (e.g., parts per million), sound is difficult to quantify because it is multi-dimensional, varying in intensity and spectra over time. Similarly, the impact of noise on humans is complex. Some noises are pleasant, such as flowing water, while others are not pleasant, such as alarms, screeching brakes, and people arguing.

Unfortunately, noise pollution is experienced in all aspects of our lives: at work, at home, and on vacation. Noise in the workplace is regulated to protect employees against loss of hearing and other injuries. The parks department is very concerned with maintaining an acceptable soundscape, and uses a combination of human observers and instrumentation to measure the impact of noise pollution such as jet fly-overs and recreation vehicles (e.g., snowmobiles and water craft).

### BRIEF SUMMARY

One embodiment of the present invention provides a method. According to the method, sounds occurring within the given environment over a given period are monitored, and signals that each represent an amplitude of the sounds occurring within the given environment during a portion of the given period are generated. Average noise levels associated with the given environment over the given period are determined, and peak noise events occurring within the given environment over the given period are identified. The average noise levels and information indicating the peak noise events are stored or transmitted.

Another embodiment of the present invention provides a computer program product comprising a computer readable storage medium having computer readable program code embodied therewith. The computer readable program code comprises computer readable program code configured to monitor sounds occurring within the given environment over a given period, generate signals that each represent an amplitude of the sounds occurring within the given environment during a portion of the given period, determine average noise levels associated with the given environment over the given period, identify peak noise events occurring within the given environment over the given period, and store or transmit the average noise levels and information indicating the peak noise events.

A further embodiment of the present invention provides a system. The system includes a microphone for monitoring sounds occurring within a given environment over a given period, an ambient measuring circuit and a transient measuring circuit for generating signals each representing an amplitude of the sounds occurring within the given environment during a portion of the given period, and a memory and/or a wireless communication subsystem. The ambient measuring circuit determines average noise levels associated with the given environment over the given period, and the transient measuring circuit identifies peak noise events occurring within the given environment over the given period. The average noise levels and information indicating the peak noise events are stored in the memory and/or transmitted via the wireless communication subsystem.

Other objects, features, and advantages of the present invention will become apparent from the following detailed description. It should be understood, however, that the detailed description and specific examples, while indicating various embodiments of the present invention, are given by way of illustration only and various modifications may naturally be performed without deviating from the present invention.

### BRIEF DESCRIPTION OF THE SEVERAL VIEWS OF THE DRAWINGS

FIG. 1 is a graph illustrating spectra of several noise sources;

FIG. 2 is a graph illustrating spectra of periodic noise sources;

FIG. 3 is a block diagram illustrating a noise monitoring device according to one embodiment of the present invention;

FIG. 4 is a graph illustrating the frequency response of a microphone applicable to some embodiments of the present invention;

FIG. 5 is a graph illustrating a calibration process of a microphone according to one embodiment of the present invention;

FIG. 6 is a graph showing the conversion of a microphone output voltage into a calibrated sound pressure level according to one embodiment of the present invention;

FIG. 7 is a noise model generated for a first environment according to one embodiment of the present invention;

FIG. 8 is a noise model generated for a second environment according to one embodiment of the present invention;

FIG. 9 is a graph of a 24-hour time period of minimum average sound according to one embodiment of the present invention;

FIG. 10 is a histogram of the loudest noises detected for a given environment according to one embodiment of the present invention;

FIG. 11 is a histogram of the average noise level for a given environment according to one embodiment of the present invention;

FIG. 12 illustrates an audio summary for a given environment that compresses a 24-hour period into 1-minute of audio according to one embodiment of the present invention; and

FIGS. 13 and 14 are operational flow diagrams for monitoring noise within a given environment and generating noise models according to one embodiment of the present invention.

### DETAILED DESCRIPTION

Various embodiments of the present invention will be discussed in detail herein below with reference to the attached drawings.

Embodiments of the present invention provide a noise model and wireless noise monitor that accurately and efficiently quantify noise in a given area. As an example, prospective homeowners and renters can use the wireless noise monitor to provide a quantitative objective answer to the question of how quiet is a neighborhood. In one embodiment, residential noise is modeled as an ambient background punctuated by transient events. This noise is quantified as the minimum average sound pressure level (SPL) and the number of peak sound events occurring in given windows of time (e.g., 5-minute windows). Timeline and histogram plots of these two parameters provide an objective quantitative means of comparing location-specific noise pollution. Monitored and/or calculated data is displayed to a user via a display coupled to the wireless noise monitor or through wireless transmission to another device. Short segments (e.g., 3 seconds) of sound can be recorded so humans can judge for themselves the impact that the noise has on the desirability of a residential location. Also, embodiments of the present invention can be implemented through cost-effective hardware components.

The human ear detects minute changes in air pressure as sound. The ear is incredibly sensitive, with a dynamic range (the difference between the thresholds of hearing and pain) spanning 13 orders of magnitude. Table 1 shows the sound pressure levels in decibels of common loudness references.

TABLE 1

| Decibels | Sound |
|---|---|
| 0 | Threshold of hearing |
| 20 | Rustling leaves |
| 30 | Whisper, quiet library |
| 50-70 | Normal conversation at 3 to 5 feet |
| 75 | Loud Singing |
| 80 | Telephone dial tone |
| 90 | Train whistle at 500 feet, motorcycle, lawnmower |
| 95 | Subway at 200 feet |
| 100 | Diesel truck at 30 feet |
| 110 | Jack hammer, rock concert |
| 120-140 | Jet engine at 300 feet |
| 180 | Death of hearing tissue |

To accommodate the large dynamic range, the SPL is measured in logarithmic units of decibels (dB), with 0 dB defined as the threshold of hearing. A +3 dB change doubles the SPL and is the minimum increase in loudness perceivable by humans. A +10 dB increase is perceived as the doubling of loudness. Thus, a noise sensor must have a large dynamic range (e.g., 30 dB to 90 dB) but with low resolution (1-3 dB).

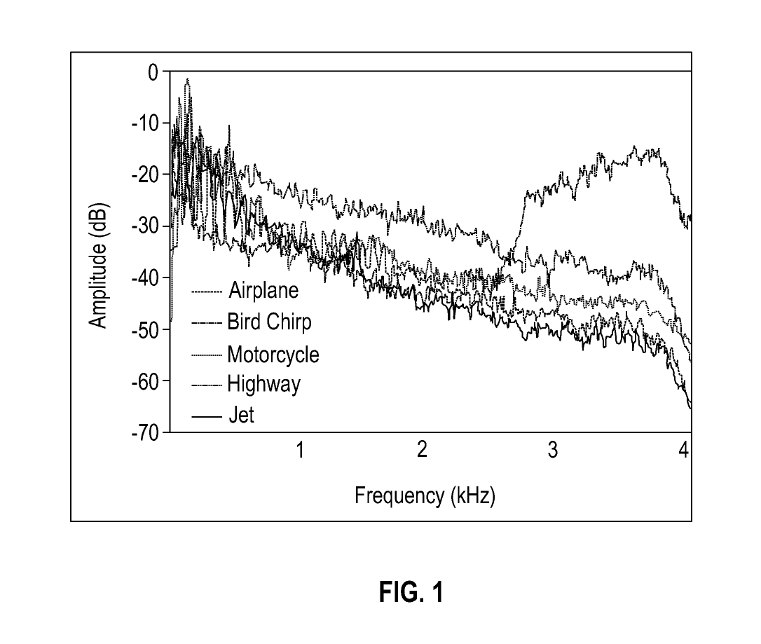

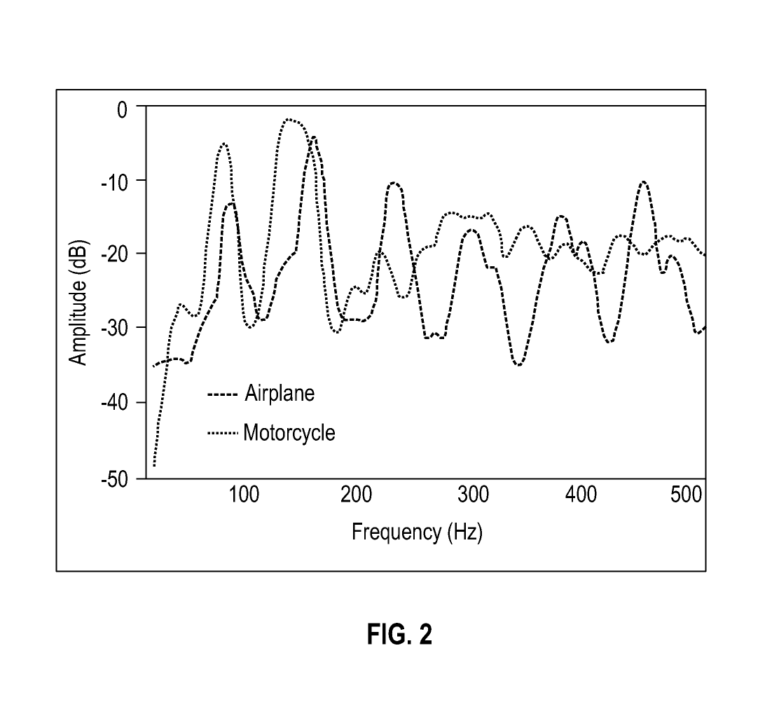

Sound varies in amplitude and frequency. Spectrum refers to the frequency components that make up a sound. White noise has energy spread equally across all frequencies. Pink noise (or 1/f noise) has a power spectral density inversely proportional to frequency and is produced from flowing water and distant highway traffic. FIG. 1 illustrates the spectra of several noise sources sampled at 8 kHz and covering a frequency range from 300 Hz to 4 kHz. Motorcycles and propeller airplanes are two noise sources that have a strong periodic component. Compressed gas emanating from the motorcycle's exhaust system and the chopping of air by the aircraft's propeller produce distant frequencies in the noise spectra, as shown in FIG. 2.

We conducted a survey of 82 people to determine if noise pollution is perceived as an important factor in choosing a place to live, and what noise pollution sources cause problems. A vast majority of surveyed people (93%) indicated that a quiet neighborhood is important in selecting a place to live, with a most (55%) indicating this as “very important”. About ⅔ of respondents recalled discovering noises in a new residence that they did not know about beforehand. The majority of respondents were likely to read and buy a noise survey. The most problematic times for noise are nights, followed by evenings and weekend mornings. Neighbors' loud music is the biggest noise complaint, with yard services and traffic noise also being top noise pollution problems. Traffic noise was the dominant noise pollution source detected in our monitoring because it happens every day.

Most people said that they do nothing in response to such noise pollution. Only about one in five people have confronted a neighbor over a noise problem and about the same number have called the police or security over a noise incident.

Embodiments of the present invention provide a noise monitoring device that monitors transient noise and ambient noise events to generate a model that summarizes and visually represents the salient features of noise pollution that impact a given location.

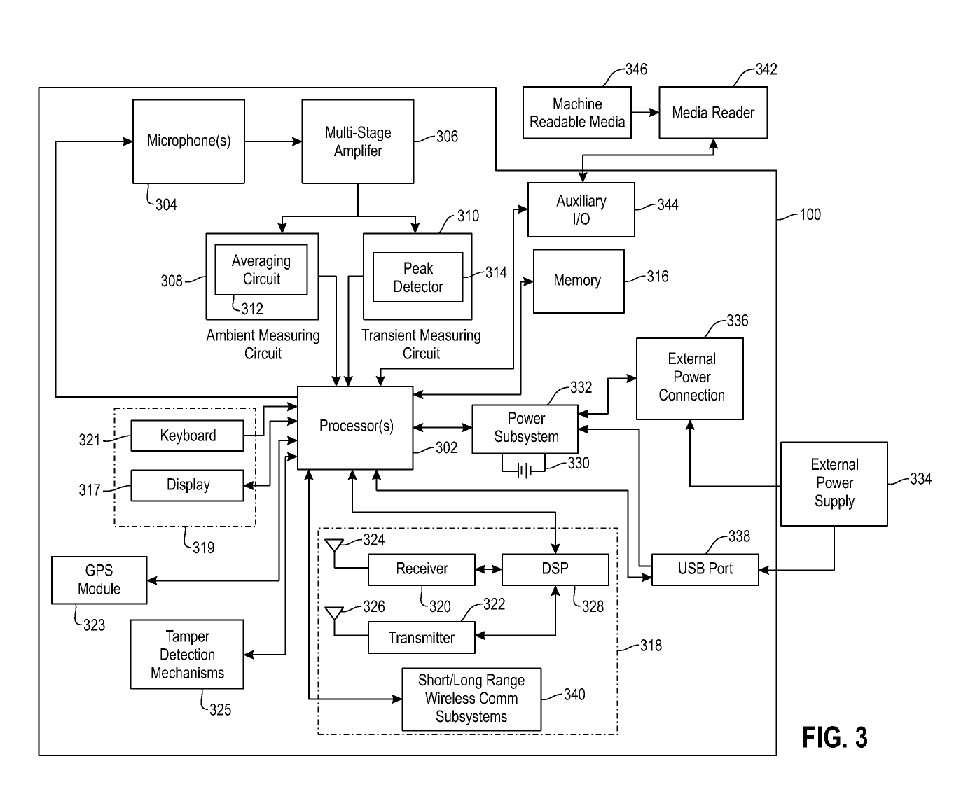

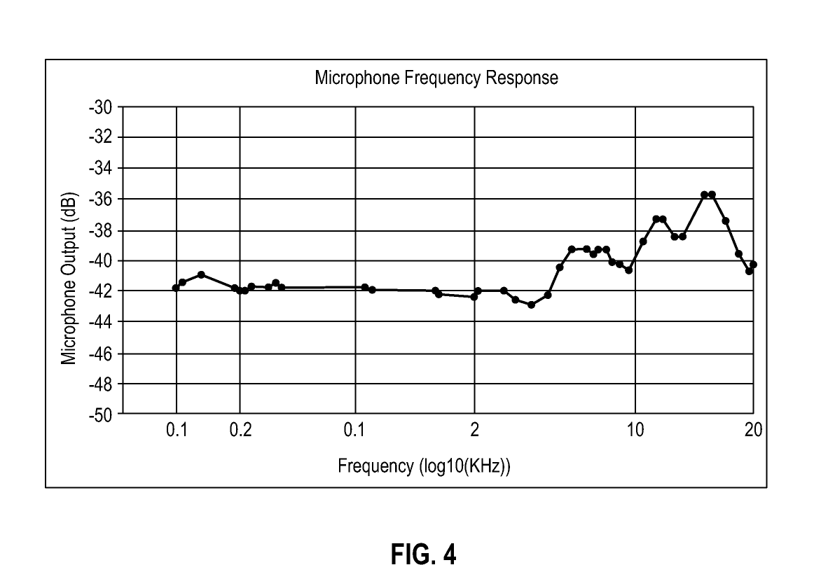

FIG. 3 shows a noise monitoring device according to one embodiment of the present invention. As shown, the noise monitoring device 300 comprises one or more processors 302. One or more microphones 304 are electrically coupled to the processor 302 and a multi-stage amplifier 306 that provides a large dynamic range. In this embodiment, the microphone 304 can be relatively small in size (e.g., 6 mm diameter), low cost (e.g., <$1), and have a flat response for the bandwidth studied (e.g., 300 to 4 kHz). However, microphones with other characteristics can be used as well.

The multi-stage amplifier 306 receives the output of the microphone 304. In this embodiment, the multi-stage amplifier 306 comprises a +30 dB preamp followed by four +15 dB amplification stages, providing selectable gains of 30 to 85 dB. However, this is not meant to be limiting and other configurations of the multi-stage amplifier 306 are also applicable. The multi-stage amplifier 306 is electrically coupled to an ambient measuring circuit 308 and a transient measuring circuit 310. Each of these circuits 308 and 310 receives the output of the multi-stage amplifier 306. The ambient measuring circuit 308 comprises an averaging circuit 312 with a heuristically determined range, such as a 5-minute time constant. The transient measuring circuit 310 comprises a peak detector 314 that counts the number of events that exceeds a given threshold, which can be determined dynamically or statically.

The outputs of the ambient measuring circuit 308 and the transient measuring circuit 310 are received by the processor 302. The processor 302 stores these outputs in a memory 316 comprising one or more memories, such as a random access memory, flash memory, or a cache memory for further processing and output to a display 317. A keyboard 321 is also included in the device 300 of this embodiment. The processor 302 is also electrically coupled to a wireless communication subsystem 318. The wireless communication subsystem 318 enables the device 300 to send and receive wireless communication signals over one or more wireless communication networks. For example, the wireless communication subsystem 318 communicates over a wireless voice or data network using a suitable wireless communications protocol. Wireless voice communications are performed using either an analog or digital wireless communication channel. Data communications allow the device 300 to communicate with other computer systems via the Internet.

The wireless communication subsystem 318 comprises a wireless receiver 320, a wireless transmitter 322, and associated circuits and components such as one or more antenna elements 324 and 326. A digital signal processor (DSP) 328 performs processing to extract data from received wireless signals and generate signals to be transmitted. The particular design of the communication subsystem 318 is dependent upon the communication network and associated wireless communications protocols which the device 300 is to communicate over.

A battery 330 is connected to a power subsystem 332 to provide power to the circuits of the device 300. The power subsystem 332 includes power distribution circuitry for providing power to the device 300 and also contains battery charging circuitry to manage the recharging of the battery 330. An external power supply 334 is able to be connected to an external power connection 336 or through a USB port 338.

The USB port 338 further provides data communication between the device 300 and one or more external devices, such as an information processing system. Data communication through the USB port 338 enables a user to set preferences through an external device or through a software application, and extends the capabilities of the device 300 by enabling information or software exchange through direct connections between the device 300 and external data sources. In addition to data communication, the USB port 338 provides power to the power subsystem 332 to charge the battery 330 or to supply power to the electronic circuits of the device 300.

Operating system software used by the processor 302 is stored in the memory 316. In this embodiment, a flash memory stores the operating system software and other executable programs, while further embodiments use a battery backed-up RAM or other non-volatile storage elements. The operating system software, device application software, or parts thereof, are able to be temporarily loaded into volatile data storage within the memory 316. Data received via wireless communication signals or through wired communications are also able to be stored in RAM as well.

A short range/long range wireless communications subsystem 340 is a further component of this embodiment for providing communication between the device 300 and other systems or devices. This subsystem 340 comprises one or more wireless transceivers, optionally associated circuits and components, and/or an optional infrared device for communicating over various networks implementing one or more wireless communication technologies, such as Bluetooth® or wireless fidelity technologies.

A media reader 342 is connected to an auxiliary I/O device 344 to allow the loading of computer readable program code of a computer program product into the device 300 for storage into memory 316. One example of a media reader 342 is an optical drive such as a CD/DVD drive, which may be used to store data to and read data from a computer readable medium or storage product such as computer readable storage media 346. Examples of suitable computer readable storage media include optical storage media such as a CD or DVD, magnetic media, or any other suitable data storage device. Media reader 342 is alternatively able to be connected to the electronic device through the USB port 338 or computer readable program code is alternatively able to be provided to the device 300 through a wireless network.

The device 300 of this embodiment also includes a global position satellite module 323 for determining the current location of the device 300. Tamper detection mechanisms 325 are also coupled to the processor 302. These mechanisms 325 can include a clock, light sensor, motion sensors, shock sensors, or the like. The tamper detection mechanisms allow the user to determine if the device 300 has been tampered with in any way. Tamper detection is important because any type of tampering can result in the data collected by the device 300 being invalid. In one embodiment, a light sensor is placed substantially near the microphone 304 to receive and monitor ambient light. This sensor outputs a brightness signal proportional to the ambient light. The processor receives this brightness signal and the time of day from a clock, and produces a tamper warning signal when changes in the brightness signal do not substantially correspond to diurnal variations in sunlight. Alternatively, the GPS module 323 can be used to detect if the location of the device 300 has been substantially changed during an installation period.

In another embodiment, tamper events are determined by identifying average noise levels for multiple locations within the given environment and peak noise events for the multiple locations. A first set of the average noise levels and a first set of the peak noise events are compared to at least a second set of the average noise levels and a second set of the peak noise events. If the first set of average noise levels and the first set of peak noise events fail to substantially match the second set of average noise levels and the second set of peak noise events, then a warning signal is generated indicating a possible tamper event.

Another mechanism for preventing tampering utilizes social networking environments. In one embodiment, measurements taken by the device 300 are published to a large audience through one or more social networks. The social network is monitored to identify people or companies that consistently report results that differ from others at the same or a similar location. In this way, social pressure will prevent “cheating”. Suspect measurements can be identified and verified by a third party. Also, a reputation management approach (e.g., user feedback ratings) can formalize the social behavior that is already loosely enforced by a social network. People or companies that repeatedly return accurate measurements can be identified by the user base and rewarded with positive feedback, while cheaters can receive negative feedback. The sum of positive and negative feedback can give an impression about the reliability of the measurements of a person or company.

As discussed above, the device 300 incorporates a wireless communication subsystem 318. This subsystem 318 can comprise individual wireless communication components or can be a physical wireless communication device such as a cellular phone. In one embodiment in which a physical wireless communication device is used, the processor 302 is hard-wired directly to the keypad of the wireless communication device through analog switches. The hardware interface allows the processor 302 to perform any phone function that a human can perform through the keypad. The processor 302, in addition to sampling sound pressure level and performing signal analysis to derive salient sound features, can also power on the wireless communication device, composes a wireless messages, press “SEND” to send the messages, turn the phone off, etc. In one embodiment, the device 300 comprises a waterproof case that houses all of its components.

The noise monitoring device 300 of this embodiment utilizes these components to monitor noise in a given environment, such as a residential area, and then model this noise as an ambient background punctuated by transient events. The noise monitoring device 300 also quantifies this noise as the minimum average source pressure level (SPL) and the number of peak sound events occurring within a given time window. The noise monitoring device 300 of this embodiment also generates timeline and histogram plots of the minimum average SPL and number of peak sound events that have occurred. These plots provide an objective quantitative mechanism for comparing location-specific noise pollution. The noise monitoring device 300 is then able to transmit this data over a wireless networks in various formats such as a text message, email message, instant message, and/or any other format for packaging and transmitting data over a wireless network.

In this exemplary embodiment, the microphone 304 of the noise monitoring device 300 is calibrated to a digital sound level meter using a white noise source. The output of the microphone 304 is fit to the sound level meter output. For example, in one embodiment, the noise monitoring device 300 is calibrated using a commercial digital sound pressure meter which has 2 dB accuracy and a 0.1 dB resolution. The sound pressure meter can be used in A-weight filter mode, which approximates the spectral sensitivity of the human ear. A white noise source such as radio static is used to calibrate the noise monitoring device 300. By varying the volume of the radio measured with the sound pressure meter, arbitrary calibrated sound pressure levels can be created.

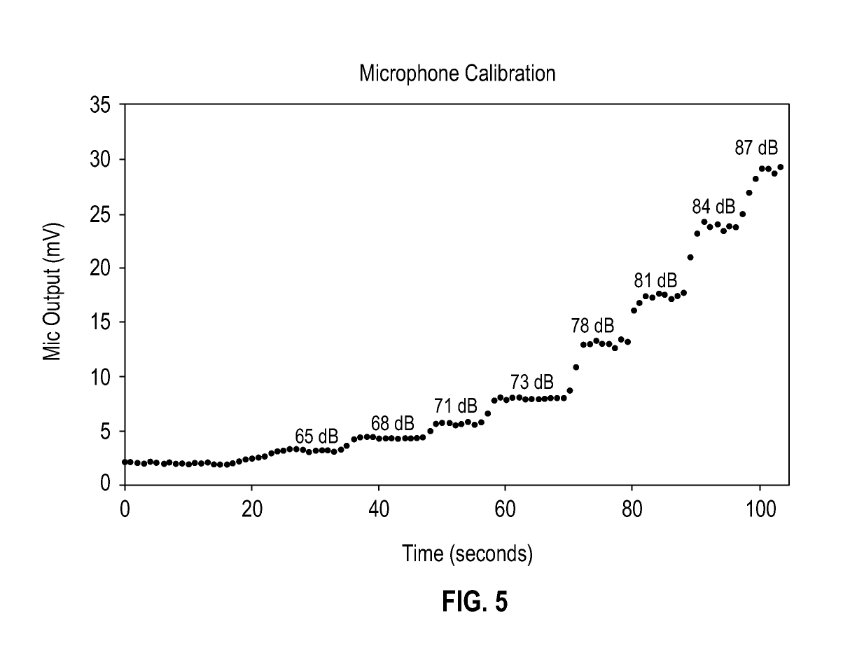

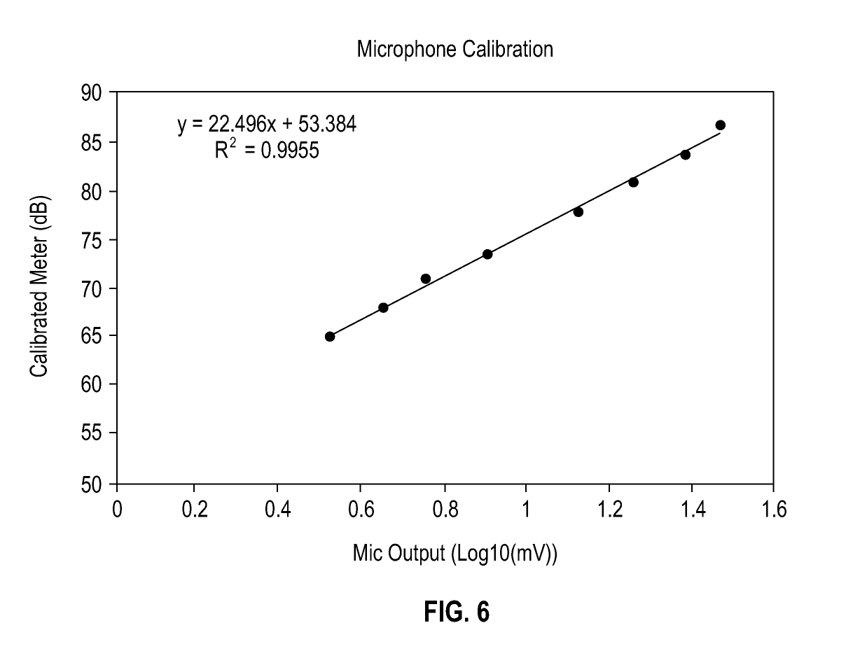

During this calibration process each gain setting of the device 300 (e.g., 4 in this embodiment) is individually calibrated. The sound recording is started and the volume of white noise is increased in +3 dB steps. FIG. 5 shows the white noise being applied at increasing amplitudes to the microphone. The sound pressure level (dB number above samples) at the microphone is measured with a sound pressure meter. The log base-10 of the average microphone output is plotted against the sound pressure measured with the sound pressure meter. FIG. 6 shows the gain and bias terms (22.496 and 53.348, respectively) used to convert microphone output voltage into calibrated sound pressure level. A linear fit of this curve produces the gain and bias terms to convert microphone output into calibrated dB units.

The following discussion gives various examples with respect to real world data collected by the noise monitoring device 300 during various experiments that were performed. In particular, the data used in the examples below was collected for three houses: House A, House B, and House C. House A was located on a residential street far from any expressway or major road, representing a suburban location. The environment surrounding House A is a very quiet location punctuated by an occasional vehicle. House B was located down an unpaved road in a large county park, representing a very rural setting. House B was next to a creek, providing a source of pink noise. Houses A and B allowed provided transient noise juxtaposed with background noise. A transient noise event (e.g., a car passing by) at House A may be perceived as more disturbing than the same magnitude event at House B because House A had a lower average sound level. However, those noise events may not be as disturbing as a constant higher level of background noise. House C was located in a dense suburban development within a few blocks of two freeways, providing a variety of human activity and transportation noise sources, as would be encountered in an urban environment.

In embodiments of the present invention, the noise monitoring device 300 is placed in an environment such as outside of a residence for a given period of time, such as a day to a week, to monitor sound in the environment. The device 300 collects and processes sound samples, and produces a noise analysis output useful for evaluating the relative impact of noise pollution at the location.

As the microphone 304 of the device 300 receives sounds from the environment, the microphone 304 outputs this data to the multi-stage amplifier 306. Each amplifier stage is sent to multiplexer channels (switches) of an analog-to-digital converter of the processor 302. This provides software selectable gains of, for example, 30 dB to 90 dB. The amplitude of the selected channel is sampled at a given sampling rate with a given linear amplitude resolution. For example, in one embodiment the sampling rate is 8 KHz with 10 bits linear amplitude resolution and +60 dB of auto-scaling for an effective dynamic range of 20 bits. We determined the sampling bandwidth of 8 KHz with 10 bits linear amplitude resolution for this embodiment by examining the spectra of noise sources recorded during a survey of potential monitoring sites during experimentation. To avoid aliasing (acoustic artifacts), the sampling frequency was selected to be at least twice the highest frequency detected (i.e., the Nyquist frequency). A low sampling rate minimizes the memory and processing power required by the noise monitoring device 300. The highest frequency event recorded at the monitoring sights was birds chirping, which has an energy between 3-4 kHz. From this analysis, we established 8 kHz as one sampling rate applicable for use with the noise monitoring device 300. However, other sampling rates and resolutions are used in further embodiments.

The samples are analyzed by the ambient measuring circuit 308 and the transient measuring circuit 310 of the device 300 in order to detect ambient components and transient events within the sampled data. The ambient measuring circuit 308 and the transient measuring circuit 310 can analyze the samples simultaneously or at different times.

The averaging circuit 312 of the ambient measuring circuit 308 rectifies (absolute value function) the samples, integrates the samples over a first given window of time (such as a one-second window), and determines the minimum sum occurring in a second given window of time (such as a five-minute window). This minimum sum is then saved as the Minimum Average. The peak detector 314 of the transient measuring circuit 310 also analyzes the samples and determines if one or more samples in a third given window of time (such as a one-second window) exceeds the previous Minimum Average by a given amplitude, such as +20 dB. If the peak detector 314 detects this, it increments a Peak Counter.

If the Minimum Average becomes too small or large, a different amplifier gain is selected, by using software automatic gain control (AGC), so as to increase the dynamic range of the system. The device 300 at one or more given intervals of time uses the wireless communication subsystem 318 to wirelessly transmit one or more data packets comprising the Minimum Average and Peak Count values. These data packets can be short message service (SMS) messages, multimedia message service (MMS) messages, emails, or any other type of data packet format. This noise analysis output (Minimum Average and Peak Counts) can also be displayed to a user via the display 317 and/or be transmitted through wired mechanisms such as the USB port.

The noise analysis output provides a quantitative analysis of the noise environment. In one embodiment, a given period of audio data is compressed into a smaller period of time to provide a qualitative representation of the noise environment. For example, 24 hours of audio data can be compressed into a one minute “collage”. The device 300 utilizes multiple (e.g., 20) short recordings (e.g., of 3 seconds) to perform this compression. This can be accomplished in various ways such as by storing the audio as analog samples using an integrated single chip solution or storing the audio digitally in a flash memory. Playing back the audio samples as an analog signal allows the device 300 to transmit the audio over a voice channel of a wireless communication network.

The audio data collected by the noise monitoring device 300 and the noise analysis output comprising the Minimum Average and Peak Counts data can be used by the device 300 and/or by another information processing system (e.g., a system that receives the wirelessly transmitted noise analysis output) to create a noise model for the monitored environment. In an example in which the sound recordings taken by the device 300 comprise common characteristics of a slowly varying ambient component (caused by traffic and water) punctuated by quick transient events (caused primarily by vehicles), the ambient component displays a cyclic variation, with a period of a day, corresponding to commuter traffic, and is most apparent in the average signal. The transient events from passing vehicles last a few seconds while aircraft flybys can last up to one minute. Transient events are detected when a noise event is above the minimum average for more than a given threshold. In one embodiment, a threshold of 20 dB is selected based on our experimentation. These two salient features are quantified by measuring the Minimum Average and counting the transient events (Peak Count) in a sampling window, as discussed above.

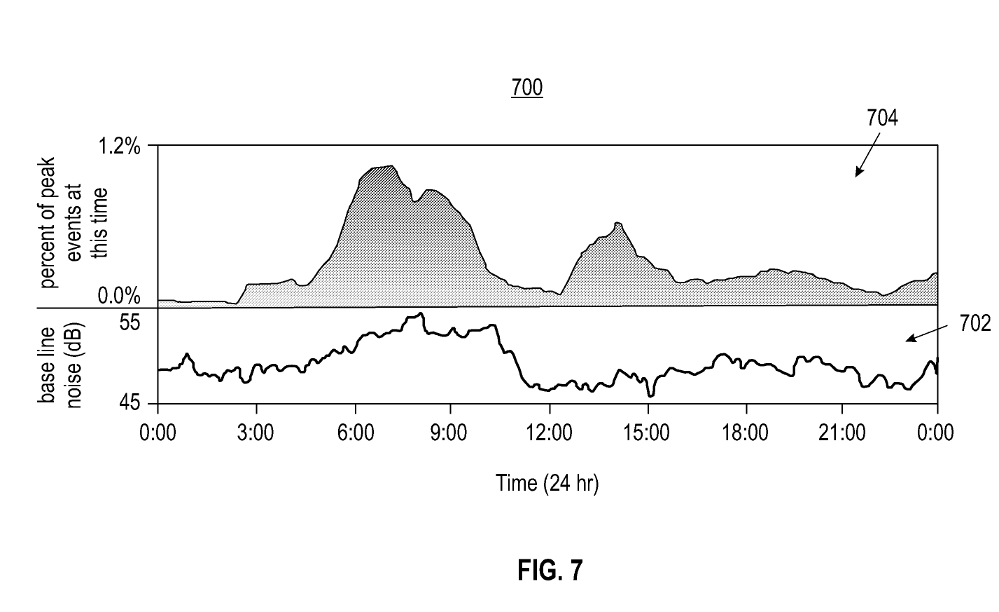

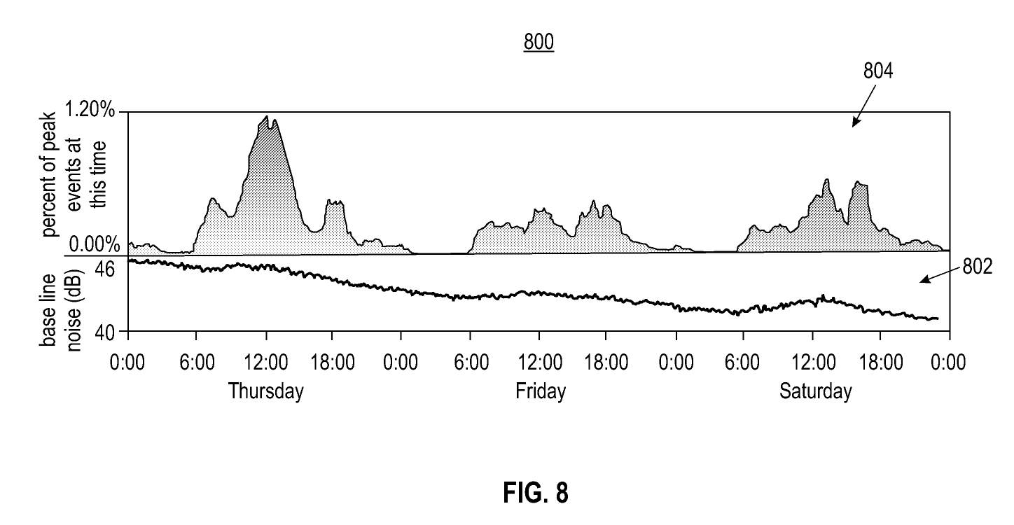

FIG. 7 shows a noise model created for House A and FIG. 8 shows a noise model created for House B in accordance with one embodiment of the present invention. These noise models are based on real world data collected by the noise monitoring device 300 for each of these houses. FIG. 7 shows the average sound pressure 702 representing the baseline noise and percent of peak events 704 defined as an instantaneous amplitude that exceeds the average by at least 20 dB. The baseline clearly shows noise from the morning commute. Transient noise events, primarily from traffic helicopters over the nearby freeways, are most frequent in the morning and early afternoon. FIG. 8 shows the peak noise events and average noise for House B. A creek adjacent to the property creates a diminishing baseline noise 802 caused by runoff from recent rain. Devoid of commuting traffic, transient events 804 at this rural location are predominantly caused by airplanes, which pass overhead in the middle of the day. On Thursday, a significantly increased number of airplanes flew over this house.

These noise models created by this embodiment of the present invention summarize and visually represent the salient features of noise pollution that impact each location. The model comprises ambient and transient components. In these examples, the ambient component (Minimum Average) and transient component (Peak Count) are displayed as a time line and histogram. The ambient component is calculated as the minimum amplitude occurring in a first sampling period. A maximum sample is calculated as the largest instantaneous amplitude occurring in a second sampling period. The transient component is calculated as the number of times the maximum sample exceeds the ambient component by a threshold in a third sampling period.

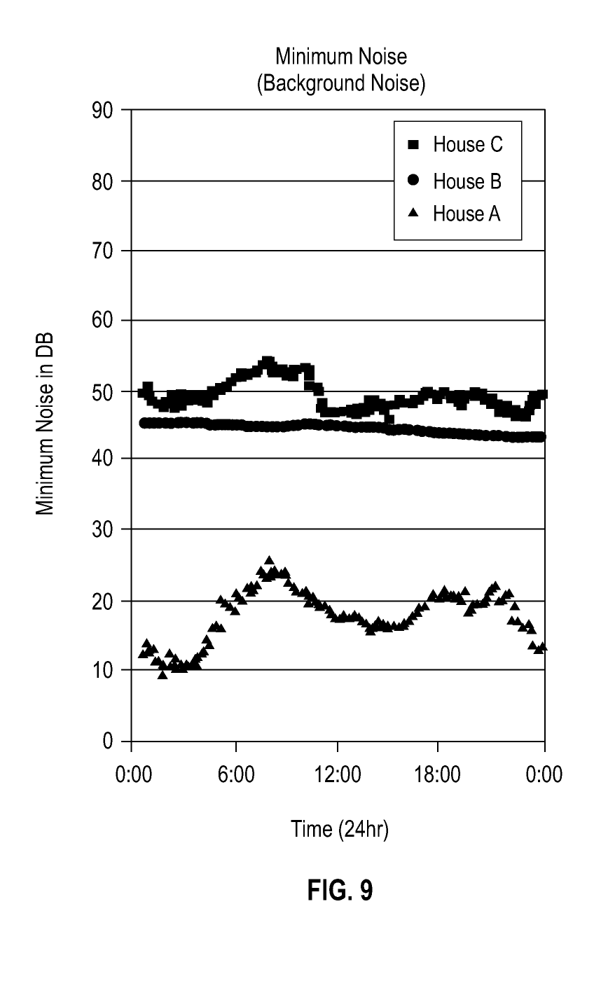

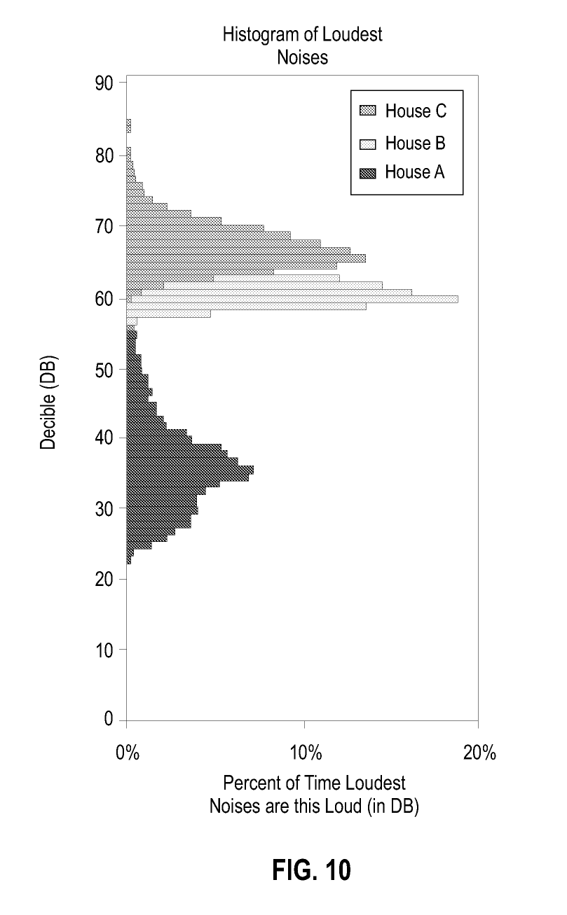

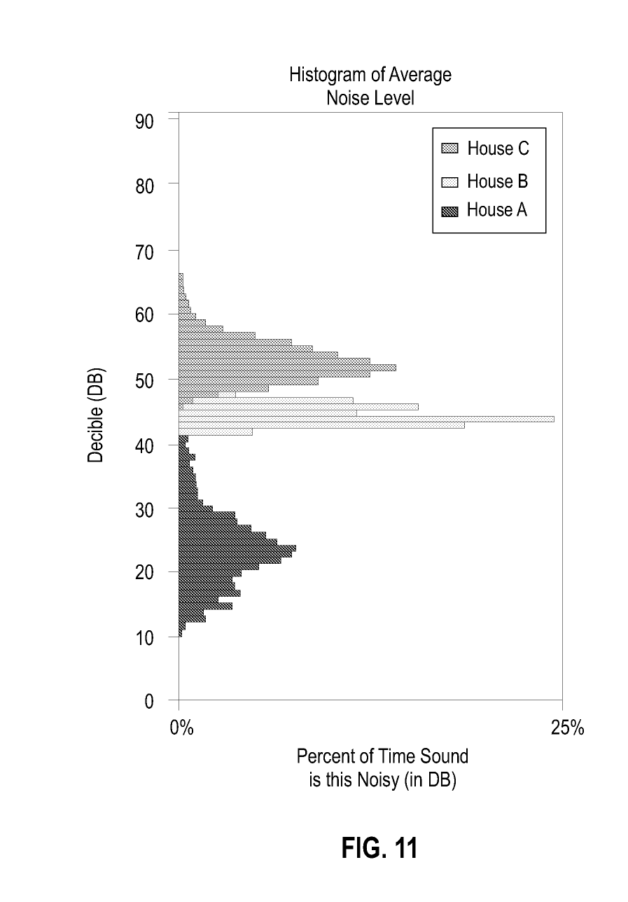

In addition to such noise models, other visual representations can be created so that a user can compare environments such as houses. For example, in one embodiment, one or more charts are created based on the noise analysis output from multiple locations. These charts can include a 24 hour timeline of the Minimum Averages for multiple locations (e.g., FIG. 9), a histogram collected over three days showing the loudest events defined as the Minimum Average at the time of a Peak Count event for multiple locations (e.g., FIG. 10), and another histogram collected over three days showing the average sound pressure level for multiple locations (e.g., FIG. 11).

FIG. 9 shows an exemplary 24-hour time period of minimum average sound in 5-minute windows. As can be seen, the urban and suburban houses (House A and House C, respectively) have peaks in the minimum noise level during morning and evening commutes. House B shows the sound of a creek adjacent to the property, which is slowly getting quieter as swell from a recent rainfall reduces. This provides an interesting side-effect in that traffic levels and water flow can be indirectly observed by monitoring Minimum Averages. Also, the noise model and the charts can be used for other applications, such as scouting scene locations for motion pictures.

FIG. 10 shows a histogram of the loudest noise through the Minimum Average at the time of peak events (indicated by the increment of the Peak Count). The narrow range of noise levels at House B indicates a predominantly constant noise level (the creek), whereas the wider bands for Houses A and C reflect the variable intensity of noise from vehicles near these locations. FIG. 11 shows a histogram of average noise level. As shown, the distribution of average noise level is similar to the distribution of loud noises, albeit centered at a lower peak. In further embodiments, other time periods are used and other graphical representations of the data are created.

In one embodiment, the loudest noise events occurring within a given period of time (such as a 24-hour period) are also presented to a user. In this embodiment, short recordings (e.g., less than 10 seconds) of noise events are saved and edited together into a single recording (e.g., of less than 5 minutes). For example, 24 hours of source monitoring is compressed into a one-minute “collage”, and for every 72 minutes of recorded audio a 3 second segment with the largest average amplitude is saved. The resulting 20 segments are played sequentially so as to provide a one-minute summary of the loudest noise events occurring in a 24 hour period. In further embodiments, other time periods are used to create the audio summary.

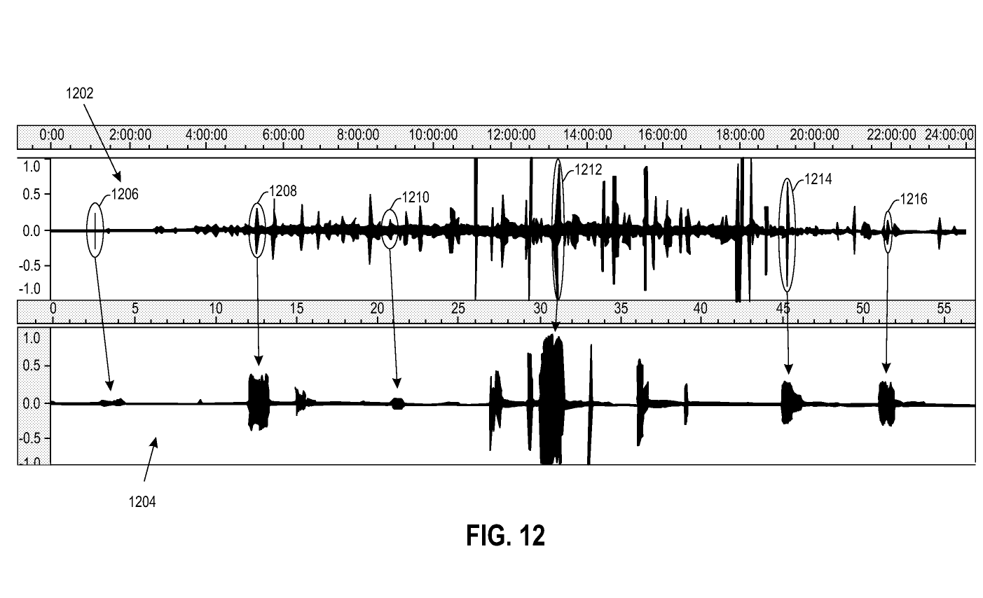

FIG. 12 shows an audio summary of noise for House A. One complete day (24 hours, from 6 am to 6 am) 1202 of audio is compressed into a one-minute summary 1204. This is done by selecting the 3 seconds of audio with the largest average amplitude from every 72 minutes of audio. The circles 1206 to 1216 in the upper time trace 1202 represent some of the audio segments selected for inclusion in the one-minute summary. The format of the upper scale is hours:minutes:seconds, while the format of the lower scale is in seconds.

Accordingly, the noise monitoring device of the present invention produces a noise model that accurately and efficiently quantifies noise in a given area. This noise model comprises ambient background punctuated by transient events. In one embodiment, noise is quantified as the minimum average sound pressure level (SPL) and the number of peak sound events occurring in given windows of time. Timeline and histogram plots of these two parameters provide an objective quantitative means of comparing location-specific noise pollution.

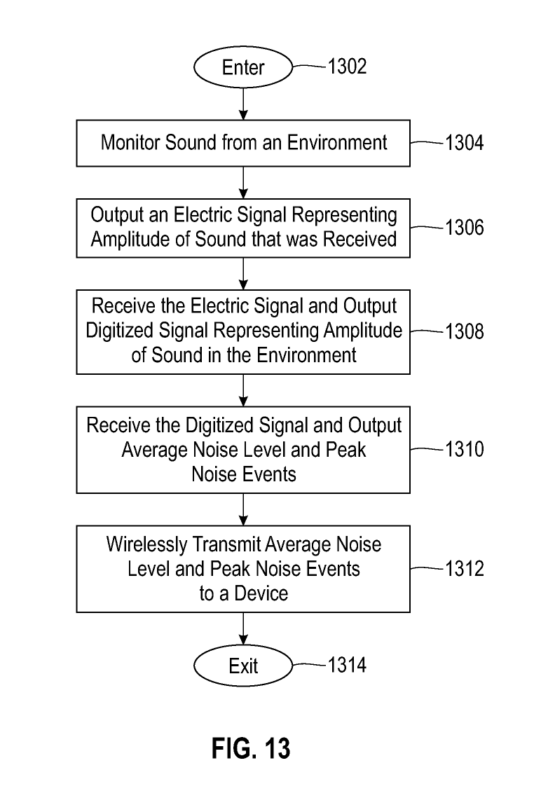

FIG. 13 is an operational flow diagram illustrating a process for modeling noise in a given environment according to one embodiment of the present invention. The operational flow diagram of FIG. 13 begins at step 1302 and flows directly to step 1304. The noise monitoring device 300 monitors sound from an environment, at step 1304. An electric signal representing the amplitude of the sound that was received is output, at step 1306. The electric signal is received and a digitized signal representing the amplitude of the sound in the environment is output, at step 1308. The digitized signal is used to output an average noise level and peak noise events, at step 1310. The average noise level and peak noise events are wirelessly transmitted to a device, at step 1312. The control flow then exits at step 1314.

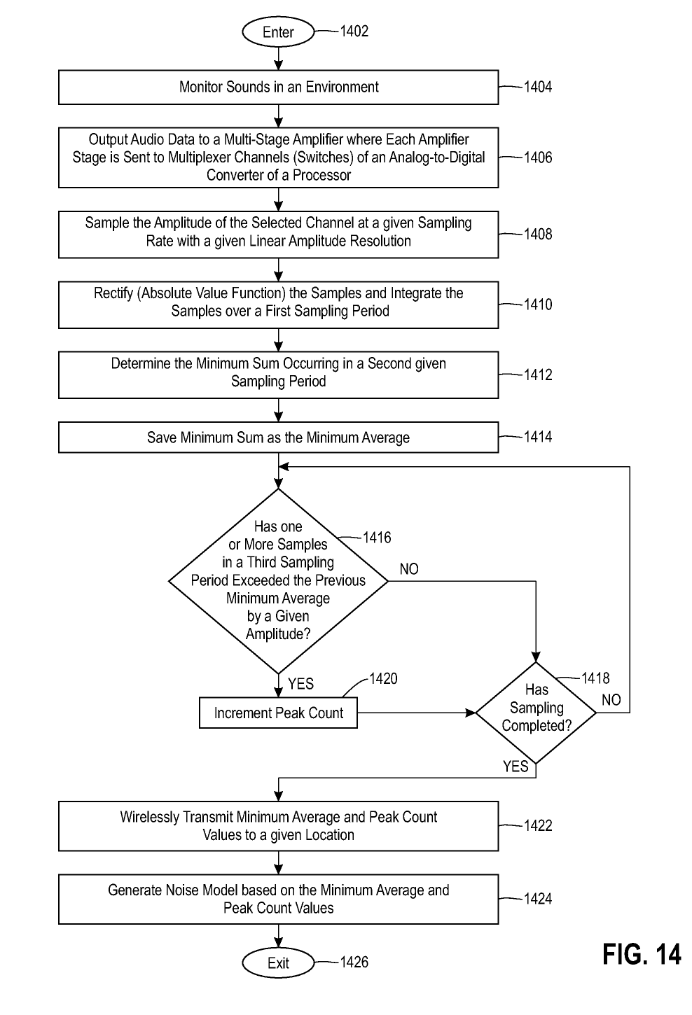

FIG. 14 is an operational flow diagram illustrating another process for modeling noise in a given environment according to another embodiment of the present invention. The operational flow diagram of FIG. 14 begins at step 1402 and flows directly to step 1404. The noise monitoring device 300 monitors sounds in an environment, at step 1404. The audio data is output to a multi-stage amplifier 306, with each amplifier stage being sent to multiplexor channels (switches) of an analog-to-digital converter of the processor 302, at step 1406. The amplitude of the selected channel is sampled at a given sampling rate with a given linear amplitude resolution, at step 1408.

The samples are rectified and integrated over a first sampling period, at step 1410. The minimum sum occurring in a second given sampling period is determined, at step 1412. The minimum sum is saved as the Minimum average, at step 1414. A determination is made as to whether one or more samples in a third sampling period exceeds the previous Minimum Average by a given amplitude, at step 1416. If the result of this determination is negative, a determination is made as to whether the sampling has completed, at step 1418. If the result of this determination is negative, the control returns to step 1416. If the result of this determination is positive, the control flows to step 1422. If the result of the determination at step 1416 is positive, the control flows to step 1422 where a Peak Count is incremented. The Minimum Average and Peak Count are wirelessly transmitted to a given location, at step 1422. A noise model is generated based on the Minimum Average and Peak Count values, at step 1424. The noise monitoring device 300 and/or the device that receives the wirelessly transmitted data generate this noise model and visually display this information to a user. The control flow then exits at step 1426.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
monitoring sounds occurring within a given environment over a given period;
generating a plurality of signals each representing an amplitude of the sounds occurring within the given environment during a portion of the given period;
determining a plurality of average noise levels associated with the given environment over the given period;
identifying a plurality of peak noise events occurring within the given environment over the given period; and
storing or transmitting the average noise levels and information indicating the peak noise events.

2. The method of claim 1, wherein generating the plurality of signals comprises:
sampling the sounds occurring within the given environment at a given sampling rate with a given linear amplitude resolution.

3. The method of claim 2, wherein, determining the plurality of average noise levels comprises:
determining a minimum amplitude of the sounds occurring within the given environment over a first sampling period; and
designating the minimum amplitude as the average noise level over that sampling period,
wherein the first sampling period is shorter than the given period.

4. The method of claim 3, wherein identifying the plurality of peak noise events comprises:
calculating a maximum sample as a largest instantaneous amplitude of the sounds occurring within the given environment over a second sampling period;
identifying a total number of times the maximum sample exceeds ambient noise components by a threshold over a third sampling period; and
designating the total number of times as the information indicating the peak noise events,
wherein the second and third sampling periods are different and are both shorter than the given period.

5. The method of claim 1, further comprising:
creating a noise model for the given environment over the given period based on the average noise levels and the information indicating the peak noise events, the noise model comprising ambient noise components based on the average noise levels and transient noise components based on the information indicating the peak noise events,
wherein the information indicating the peak noise events comprises a peak count.

6. The method of claim 5, wherein the noise model includes at least one of a timeline representing baseline noise for the given environment over the given period, a timeline of the average noise levels for the given environment over the given period, a histogram representing loudest noises for the given environment over the given period, and a histogram showing the average noise level at the time of each of the peak noise events for the given environment over the given period.

7. The method of claim 1, further comprising:
monitoring at least one tamper detection mechanism to determine if a tamper detection event has occurred.

8. The method of claim 7, wherein monitoring at least one tamper detection mechanism comprises at least one of:
receiving a brightness signal from the light sensor, and comparing the brightness signal to diurnal variations in sunlight over the given period;
receiving motion data from a motion sensor, and comparing the motion data to a motion threshold; and
receiving location data from a global positioning satellite module, and comparing the location data to a location of the given environment.

9. The method of claim 1, further comprising:
publishing a first set of data comprising at least some of the average noise levels and at least some of the peak noise events to a social networking environment; and
receiving feedback from users of the social networking environment regarding whether or not the first set of data is reliable.

10. The method of claim 1, further comprising:
selectively saving a plurality of short recordings of noise events occurring within the given environment over the given period; and
combining the plurality of short recordings together into a single recording.

11. The method of claim 10, wherein the plurality of short recordings are recordings of the peak noise events occurring within the given environment over the given period, so that the single recording provides a summary of the loudest noise events occurring within the given environment over the given period.

12. The method of claim 10, wherein each of the short recordings is less than 10 seconds and the single recording is less than 5 minutes.

13. A computer program product comprising a computer readable storage medium having computer readable program code embodied therewith, the computer readable program code comprising:
computer readable program code configured to:
monitor sounds occurring within a given environment over a given period;
generate a plurality of signals each representing an amplitude of the sounds occurring within the given environment during a portion of the given period;
determine a plurality of average noise levels associated with the given environment over the given period;
identify a plurality of peak noise events occurring within the given environment over the given period; and
store or transmit the average noise levels and information indicating the peak noise events.

14. The non-transitory computer readable medium of claim 13, wherein generating the plurality of signals comprises:
sampling the sounds occurring within the given environment at a given sampling rate with a given linear amplitude resolution.

15. The non-transitory computer readable medium of claim 13, wherein the computer readable program code is further configured to:
create a noise model for the given environment over the given period based on the average noise levels and the information indicating the peak noise events, the noise model comprising ambient noise components based on the average noise levels and transient noise components based on the information indicating the peak noise events,
wherein the information indicating the peak noise events comprises a peak count.

16. The non-transitory computer readable medium of claim 13, wherein the computer readable program code is further configured to:
selectively save a plurality of short recordings of noise events occurring within the given environment over the given period; and
combine the plurality of short recordings together into a single recording.

17. A system comprising:
a microphone for monitoring sounds occurring within a given environment over a given period;
an ambient measuring circuit and a transient measuring circuit for generating a plurality of signals each representing an amplitude of the sounds occurring within the given environment during a portion of the given period; and
at least one of a memory and a wireless communication subsystem,
wherein the ambient measuring circuit determines a plurality of average noise levels associated with the given environment over the given period,
the transient measuring circuit identifies a plurality of peak noise events occurring within the given environment over the given period, and
the average noise levels and information indicating the peak noise events are at least one of stored in the memory and transmitted via the wireless communication subsystem.

18. The system of claim 17, wherein the ambient measuring circuit samples the sounds occurring within the given environment at a given sampling rate with a given linear amplitude resolution.

19. The system of claim 17, further comprising:
a processor for creating a noise model for the given environment over the given period based on the average noise levels and the information indicating the peak noise events, the noise model comprising ambient noise components based on the average noise levels and transient noise components based on the information indicating the peak noise events,
wherein the information indicating the peak noise events comprises a peak count.

20. The system of claim 17, further comprising:
a processor,
wherein a plurality of short recordings of noise events occurring within the given environment over the given period are stored in the memory, and
the processor combines the plurality of short recordings together into a single recording.
